(19) United States
(12) Patent Application Publication
(10) Pub. No.: US 2023/0243194 A1
(43) Pub. Date: Aug. 3, 2023

(54) DOOR LOCK CONTROL SYSTEM

(71) Applicant: KABUSHIKI KAISHA TOKAI RIKA DENKI SEISAKUSHO, Aichi (JP)

(72) Inventors: SOICHIRO MATSUI, Toyota-shi (JP); Cheng Shu Guo, Miyoshi-shi (JP); Tomoaki Akasaki, Toyota-shi (JP); Satoshi Sasaki, Aichi (JP); Takatomo Mizuno, Aichi (JP)

(73) Assignee: KABUSHIKI KAISHA TOKAI RIKA DENKI SEISAKUSHO, Aichi (JP)

(21) Appl. No.: 18/162,721

(22) Filed: Feb. 1, 2023

(30) Foreign Application Priority Data
Feb. 2, 2022 (JP) 2022-014657

(51) Int. Cl. E05B 81/58; E05B 81/04

(52) U.S. Cl. CPC E05B 81/58; E05B 81/04

(57) ABSTRACT

A door lock control system includes: a motor, actuating a door lock; a power supply, supplying power to the motor; a first relay and a second relay, arranged in series between the motor and the power supply; a switch, operated by a user; a body ECU, turning on the first relay for a predetermined time in response to the switch being operated; and a timer IC, turning on the second relay for a predetermined time in response to the switch being operated.

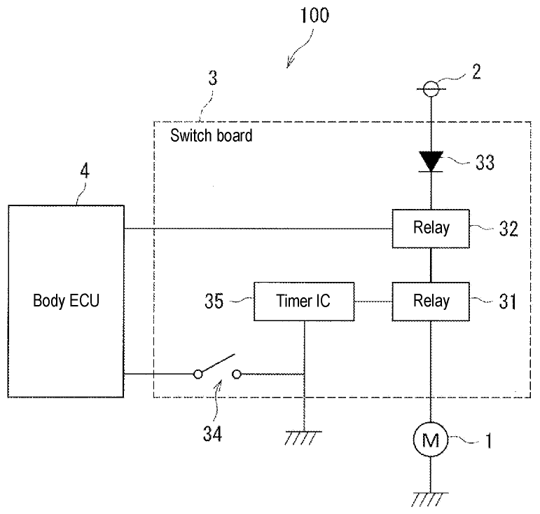

### CROSS-REFERENCE TO RELATED APPLICATIONS

This application claims the priority benefit of Japan Application No. 2022-014657, filed on Feb. 2, 2022. The entirety of the above-mentioned patent application is hereby incorporated by reference herein and made a part of this specification.

### BACKGROUND

### Technical Field

The disclosure relates to a door lock control system.

### Related Art

Conventionally, a door lock control system that electrically controls a door lock is known (see, for example, Patent Document 1 (Japanese Patent Laid-open No. 2020-114040)).

The door lock control system of Patent Document 1 includes a motor actuating a door lock, a power supply for supplying power to the motor, a relay arranged between the motor and the power supply, and a body electronic control unit (ECU) controlling the relay. The body ECU is configured to lock and unlock the door lock by controlling the motor using the relay.

Here, in the case where the door lock is electrically controlled by the body ECU as described above, if the body ECU fails, there is a fear that the door lock may be actuated unexpectedly, and there is room for improvement in safety.

### SUMMARY

A door lock control system according to the disclosure includes: a motor, actuating a door lock; a power supply, supplying power to the motor; a first relay and a second relay, arranged in series between the motor and the power supply; a switch, operated by a user; a body ECU, turning on the first relay for a predetermined time in response to the switch being operated; and a timer IC, turning on the second relay for a predetermined time in response to the switch being operated.

### BRIEF DESCRIPTION OF THE DRAWINGS

The FIGURE illustrates a door lock control system of the present embodiment.

### DESCRIPTION OF THE EMBODIMENTS

The disclosure provides a door lock control system in which safety is able to be improved.

By providing a first relay controlled by a body ECU and a second relay controlled by a timer IC, even if the body ECU fails and the first relay is turned on, the second relay remains off unless a switch is operated, and unexpected actuation of a door lock is prevented. Thus, safety can be improved.

According to the door lock control system of the disclosure, safety can be improved.

One embodiment of the disclosure is described below.

First, a configuration of a door lock control system 100 according to one embodiment of the disclosure is described with reference to the FIGURE.

The door lock control system 100 is configured to electrically control a door lock (not shown). As shown in the FIGURE, the door lock control system 100 includes a motor 1, a power supply 2, a switch board 3, and a body ECU 4.

The motor 1 is a power source that actuates the door lock, and is configured to be able to switch the door lock from a locked state to an unlocked state. The power supply 2 is for driving the motor 1 and is provided to supply power to the motor 1.

The switch board 3 is provided with a relay 31, a relay 32, a diode 33, a switch 34 and a timer IC 35. The relay 31 and the relay 32 are respectively examples of a “second relay” and a “first relay” of the disclosure.

The relays 31 and 32 and the diode 33 are arranged in series between the motor 1 and the power supply 2. The relays 31 and 32 are, for example, semiconductor relays, and are provided to connect or disconnect the motor 1 and the power supply 2. The relay 31 is arranged between the motor 1 and the relay 32, and is configured to be controlled by the timer IC 35. The relay 32 is arranged between the relay 31 and the diode 33, and is configured to be controlled by the body ECU 4. The diode 33 has an anode connected to the power supply 2 and a cathode connected to the relay 32.

The switch 34 is operated by a user when releasing the door lock, and is provided, for example, on a steering wheel. The switch 34 is configured to output an ON signal to the timer IC 35 and the body ECU 4 in the case of being operated by the user. The timer IC 35 is provided to control the relay 31. Specifically, the timer IC 35 is configured to turn on the relay 31 for a predetermined time in the case where the ON signal of the switch 34 is detected.

The body ECU 4 is connected to an in-vehicle network (not shown) and is configured to be able to acquire information about a vehicle. Based on the acquired information about the vehicle, the body ECU 4 is able to determine a state of the vehicle. The body ECU 4 has a function of controlling the relay 32. Specifically, the body ECU 4 is configured to turn on the relay 32 for a predetermined time when the vehicle is in a state allowing releasing of the door lock in the case where the ON signal of the switch 34 is detected.

Next, a door lock releasing operation in the door lock control system 100 of the present embodiment is described with reference to the FIGURE. Before the start of the door lock releasing operation, the door lock is locked and the relays 31 and 32 are turned off.

First, when the switch 34 is operated by the user, the ON signal of the switch 34 is input to the timer IC 35 and the body ECU 4. When the timer IC 35 detects the ON signal of the switch 34, the relay 31 is turned on by the timer IC 35. When the body ECU 4 detects the ON signal of the switch 34, the relay 32 is turned on by the body ECU 4 if the vehicle is in the state allowing releasing of the door lock. In this way, by turning on the relays 31 and 32, the motor 1 and the power supply 2 are electrically connected, and power may be supplied from the power supply 2 to the motor 1. Then, the motor 1 is driven by the power from the power supply 2, thereby switching the door lock from the locked state to the unlocked state. When a predetermined time has elapsed since the relays 31 and 32 are turned on, by returning the relays 31 and 32 to off, the motor 1 and the power supply 2 are cut off. The predetermined time is a preset time, and is, for example, time required for the door lock releasing operation. If the vehicle is in a state prohibiting releasing of the door lock, the relay 32 remains off and the door lock is not released.

Here, in the door lock control system 100 of the present embodiment, if the body ECU 4 fails, it is conceivable that the body ECU 4 may turn on the relay 32 even if the switch 34 is not being operated. In this way, even if the relay 32 is turned on due to a failure of the body ECU 4, the relay 31 remains off unless the switch 34 is operated. Accordingly, the motor 1 and the power supply 2 are cut off, so that the door lock is prevented from being released unexpectedly even if the body ECU 4 fails.

In the present embodiment, as described above, by providing the relay 32 controlled by the body ECU 4 and the relay 31 controlled by the timer IC 35, even if the body ECU 4 fails and the relay 32 is turned on, the relay 31 remains off unless the switch 34 is operated, and unexpected releasing of the door lock is prevented. Thus, safety can be improved. That is, by allowing the body ECU 4 to share the function of controlling the relay 32 and allowing the timer IC 35 to share the function of controlling the relay 31, functional safety standards such as ISO 26262 can be complied with.

In order to comply with the functional safety standards, it is also conceivable to add a door lock ECU (not shown) controlling the door lock and perform mutual monitoring between the door lock ECU and the body ECU 4. However, when the door lock ECU is added, costs may be increased and a development schedule may be lengthened. Accordingly, in the present embodiment, by controlling the relay 31 using the timer IC 35, costs may be reduced and the development schedule may be shortened.

The embodiment disclosed herein is illustrative in every respect, and does not serve as a basis for restrictive interpretation. Therefore, the technical scope of the disclosure is defined based on claims rather than being interpreted as limited to the above embodiment. The technical scope of the disclosure may include all modifications within the meaning and range of equivalency of the claims.

The disclosure may be used for a door lock control system that electrically controls a door lock.

What is claimed is:

1. A door lock control system, comprising:
a motor, actuating a door lock;
a power supply, supplying power to the motor;
a first relay and a second relay, arranged in series between the motor and the power supply;
a switch, operated by a user;
a body ECU, turning on the first relay for a predetermined time in response to the switch being operated; and
a timer IC, turning on the second relay for a predetermined time in response to the switch being operated.
